(19) United States
(12) Patent Application Publication
(10) Pub. No.: US 2023/0168067 A1
(43) Pub. Date: Jun. 1, 2023

(54) INTEGRATED WIRELESS PUSH-TO-TALK AND ILLUMINATION MODULE

(71) Applicant: First-Light USA, LLC, Seymour, IL (US)

(72) Inventor: Jeremy B. Ross, Monticello, IL (US)

(21) Appl. No.: 17/938,623

(22) Filed: Oct. 6, 2022

Related U.S. Application Data
(60) Provisional application No. 63/264,619, filed on Nov. 29, 2021.

(51) Int. Cl. F41G 11/00; F41G 1/35; H04W 4/10

(52) U.S. Cl. CPC F41G 11/00; F41G 1/35; H04W 4/10

(57) ABSTRACT

A module adapted for attachment to a firearm includes a PTT accessory for a radio frequency communication device separate from the module and an illumination element. The PTT accessory and illumination element each have associated activation buttons, which are preferably differentiable from one another by their shape and/or method of activation. The module is adapted to be fitted to the firearm so that either or both of the activation buttons is/are accessible by a user when holding/gripping the firearm, for example, in proximity to an expected position of a user's strong hand index finger or other finger used for the trigger of the firearm when the user is holding the firearm.

### RELATED APPLICATIONS

This is a NONPROVISIONAL of, claims priority to, and incorporates by reference U.S. Provisional Application 63/264,619, filed 29 Nov. 2021.

### FIELD OF THE INVENTION

The present invention relates to an integrated wireless push-to-talk and illumination module for attachment to a rifle or other element carried by a law enforcement officer, soldier, hunter, or other individual.

### BACKGROUND

Military and law enforcement professionals rely on accessory push-to-talk (PTT) adapters for various communication devices. PTT adapters allow use of such devices with minimal movement, allowing the operator to maintain a posture of readiness and keeping the operator's hands up and in front of his/her body, e.g., when communicating via two-way radios. These adapters function by allowing an accessory PTT button or an integrated PTT button and microphone module to be positioned more ideally than having to locate and depress a PTT button that is located on the radio, etc. It is common for these adapters to be attached to the epaulet of a uniform or on a ballistic vest.

U.S. Pat. No. 9,591,255 to Sakiewicz et al. describes an attachment for a firearm that communicates with remote devices or persons such as emergency services. The attachment is adapted to be secured on a Picatinny rail, Weaver rail, or other mount, and includes a button that allows a user to initiate communication with emergency services without removing his or her hands from the firearm.

U.S. PGPUB 2006/0025078 of Sinha et al. describes a wireless PTT switch for a handgun. When the switch is activated, a signal is sent to an external, nearby two-way communication device. The signal is capable of actuating the microphone of the two-way communication device and causing transmission. In doing so, the user may use the communication device while keeping two hands on the handgun.

### SUMMARY OF THE INVENTION

In various embodiments, the present invention provides an integrated wireless PTT and illumination module that enables discreet weapon-mounted illumination and/or communication e.g., for navigation in darkened environments, eliminating a user's need to rely on a high-lumen output weapon light. Such a module also allows for viewing articles (such as identification documents), note-taking, and other tasks while a rifle is slung on the user's chest or vest. Conveniently, the integrated wireless PTT and illumination module is disposed on the user's weapon in close proximity to the user's index finger (e.g., the index finger of the user's strong hand or, if not the index finger, the finger used for the trigger of the rifle), allowing for operation of the integrated wireless PTT and illumination module by said finger when it is positioned in a ready (not firing) position with respect to the weapon (e.g., forward of a trigger and indexing a magazine below a magazine release button).

A further embodiment of the invention provides a module adapted for attachment to a firearm. The module includes a PTT accessory for a radio frequency communication device separate from the module. The PTT accessory has an associated first activation button on the module and the PTT accessory is configured to emit a wireless signal when activated by the first activation button. The module also includes an illumination element and its associated second activation button, which is an activation button different from the first activation button. The module is adapted to be fitted to the firearm so that the first activation button is accessible by a user when holding/gripping the firearm, that is, when grasping the firearm by its grip. For example, the first activation button may be positioned in proximity to an expected position of a user's finger (e.g., the user's strong hand index finger or other finger used for the trigger of the firearm) when the user is holding the firearm. Similarly, the module may be adapted to be fitted to the firearm so that the second activation button is accessible by the user when holding/gripping the firearm. For example, the second activation button may be positioned in proximity to the first activation button, but shaped differently than the first activation button or configured to be activated in a manner different from the first activation button so that the two are not inadvertently confused by the user.

Yet a further embodiment of the invention provides an illumination module for a firearm. The illumination module includes an illumination element and an activation button for the illumination element. The illumination module is adapted to be fitted to the firearm about a magazine well thereof and, when so fitted, to project light along an axis which is parallel to a plane defined by a magazine when seated in the magazine well. The illumination direction may be adjustable, at least somewhat. Also, the position of the illumination element with respect to the firearm may be adjustable along the direction of illumination of the illumination element.

### BRIEF DESCRIPTION OF THE DRAWINGS

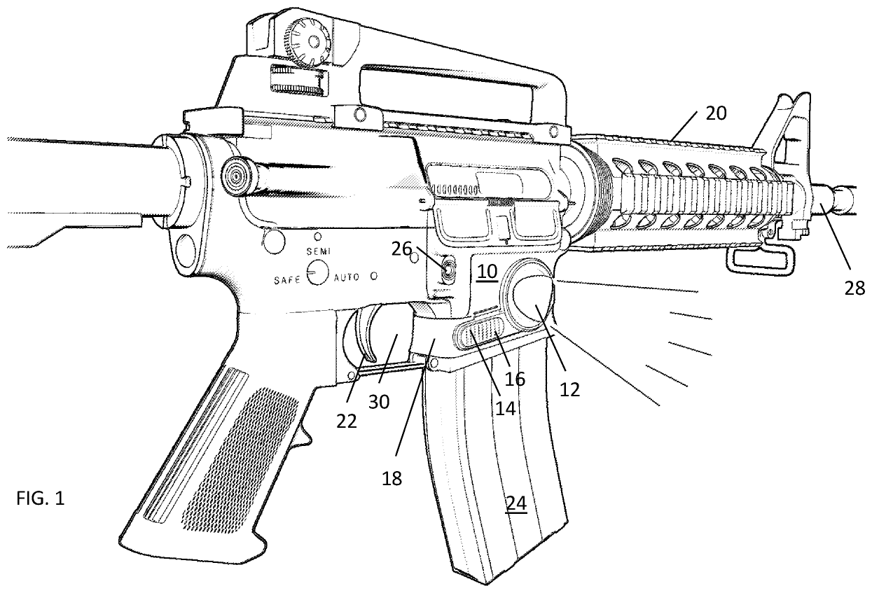

The present invention is illustrated by way of example, and not limitation, in the accompanying FIG. 1, which shows an example of an integrated wireless PTT and illumination module configured in accordance with an embodiment of the present invention and affixed to a rifle.

### DESCRIPTION

Wireless radio frequency (RF) technologies such as Near Field Magnetic Induction (NFMI), Bluetooth™, and “rolling code” RF transmitters and corresponding receivers (e.g., as are used in garage door openers and automotive “key fobs”) provide wireless communication for various kinds of modules. When used as communication elements for embodiments of the present invention, such systems allow for positioning of a PTT adapter separate from the communication device with which it is associated. Briefly, when activated the PTT adapter emits a wireless signal that is received by a receiver that is communicatively coupled to the communication device. The PTT adapter provides a button for a user to press to activate PTT functionality as well RF signal processing and transmission circuitry for communication with the receiver associated with the communication device.

In accordance with embodiments of the present invention, wireless PTT modules can be affixed in one or more locations on a user's clothing or equipment, including in one or more locations on a rifle. In one preferred embodiment, illustrated in FIG. 1, a wireless PTT module 10 is configured to be affixed to a rifle 20, forward of a trigger 22 and indexing a magazine 24 below a magazine release button 26. When placed in this location, the wireless PTT module 10 is in close proximity to the expected position of a user's finger, e.g., the user's strong hand index finger or other finger used for the trigger of the rifle, allowing for operation of the integrated wireless PTT module 10 by said finger when it is positioned in a ready (not firing) position with respect to the rifle 10. The wireless PTT module is integrated with an illumination element 12.

The wireless PTT module 10 is distinct from other wireless PTT modules offered by various vendors, which modules are designed to be attached to a Picatinny rail or similar mounting point on the rifle and, as such, require the user to operate the PTT module with his or her support, or non-dominant, hand. This can tie up the support hand from doing other things such as opening doors, pushing back assailants, signaling/waving to others, or a host of other tasks within the tactical environment. The present wireless PTT module, by virtue of being configured to mount to the rifle in close proximity to the expected position of a user's finger, is thus preferable over other, conventional PTT modules because it is safely positioned on the rifle so as to be activated by, for example, the strong, or dominant hand, which continuously grasps the rifle grip in tactical environments. Moreover, by being so configured the present wireless PTT module is positioned so that the user can activate the PTT button with his/her finger (e.g., strong-hand index finger) while maintaining proper firearm safety, which requires that the index finger or other finger used for the trigger is extended forward and resting against the magazine well, below the magazine release button and outside of the trigger guard, until ready to fire the rifle.

As shown in FIG. 1, in addition to providing a wireless PTT capability, the module 10 also houses an adjustable light emitting diode (LED) illuminator (or other illumination device) 12 that can be used for navigating darkened environments while maintaining a proper grip on the rifle 20. This illuminator 12 could potentially be bright enough to engage targets, but preferably is used in conjunction with a separate high-lumen, weapon mounted flashlight used for engaging targets. The adjustable LED illuminator housed within the module 10 may therefore be purposefully used for navigation, illumination while taking notes, or other activities where more discreet lighting is preferred. As with the activation button for the wireless PTT module, an activation button for the LED illuminator may be positioned so that the user can activate the LED illuminator with his/her finger (e.g., strong-hand index finger) while maintaining proper firearm safety. The two activation buttons may thus be positioned in proximity to one another.

Where an individual activation button 14 for the PTT capability and an individual activation button 16 for the illuminator 12 are provided, they may be positioned and/or configured so that the user does not confuse the two. For instance, the two may be shaped differently from one another Also, or alternatively, the activation button 16 may be configured for activating the illuminator 12 when depressed in a downward, vertical direction, while the activation button 14 for the PTT capability may be configured for activating the PTT functionality when pressed in a horizontal direction defined by a plane that is parallel to the barrel 28 of the rifle 20 and perpendicular to a plane defined by the magazine 24 of the rifle when fully seated into the magazine well. The direction of illumination of the illuminator 12 is adjustable along an axis which is parallel to a plane defined by the magazine 24 of the rifle when fully seated into the magazine well. This provides a down casting of light to illuminate the forward path of the user when walking. The illumination direction may be adjustable, at least somewhat. Also, the position of the illuminator 12 with respect to the rifle may be adjustable (e.g., slidable along a rail) along the direction of illumination of the illuminator.

Both the illuminator and the PTT module can be powered from a common power source such as rechargeable lithium batteries, alkaline batteries, lithium metal batteries, or lithium coin cell batteries, as is the case with the illustrated embodiment.

The present PTT module 10 and/or the illuminator 12 can be attached to the rifle 20 using traditional fastening screws, which would require drilling and tapping the magazine well, or with high-bond adhesive tape, or with an elastic rubber retention strap 18 that surrounds the magazine well forward of the trigger opening 30. The rubber retention strap 18 may be secured around the magazine well by means of a hook and latch system, a buckle mechanism, hook and pile fabric such as Velcro®, magnets, or other securement device typically used to connect and secure strap ends. Using both a rubber retention strap and high-bond adhesive tape on the backside of the module that contacts the magazine well may also be preferred. An injection molded module housing that surrounds the magazine well could also be used. The module housing may use a two-piece design that surrounds the magazine well and is secured using screws or hinged, so it can be positioned around the magazine well and secured with a screw or locking tab. It is preferred that the module does not require the user to remove the trigger guard of the rifle for installation.

Thus, in one embodiment the present invention provides a module adapted for attachment to a firearm. The module includes a PTT accessory for a radio frequency communication device separate from the module. The PTT accessory has an associated first activation button on the module and the PTT accessory is configured to emit a wireless signal when activated by the first activation button. The module also includes an illumination element and its associated second activation button, which is an activation button different from the first activation button. The module is adapted to be fitted to the firearm so that the first activation button is accessible by a user when holding/gripping the firearm, that is, when grasping the firearm by its grip. For example, the first activation button may be positioned in proximity to an expected position of a user's finger (e.g., the user's strong hand index finger or other finger used for the trigger of the firearm) when the user is holding the firearm. Similarly, the module may be adapted to be fitted to the firearm so that the second activation button is accessible by the user when holding/gripping the firearm. For example, the second activation button may be positioned in proximity to the first activation button, but shaped differently than the first activation button or configured to be activated in a manner different from the first activation button so that the two are not inadvertently confused by the user.

In yet a further embodiment, the invention provides an illumination module for a firearm. The illumination module includes an illumination element and an activation button for the illumination element. The illumination module is adapted to be fitted to the firearm about a magazine well thereof and, when so fitted, to project light along an axis which is parallel to a plane defined by a magazine when seated in the magazine well. The illumination direction may be adjustable, at least somewhat. Also, the position of the illumination element with respect to the firearm may be adjustable along the direction of illumination of the illumination element.

Although the illustrated embodiment of the invention is designed to accommodate a right-handed user, it could be modified to allow for strong-hand activation by a left-handed user. This could be accomplished by providing separate PTT button and illumination modules or tethering them together with a flexible wire or cable that allows them to be reoriented and repositioned on the opposite side of the magazine well. It is also possible for the accessory PTT module to be offered in either a right-hand or left-hand configuration.

A PTT-only module, or an adjustable illumination-only module could also be offered independently of an integrated wireless PTT and illumination module, in which case the button configuration and other features of the invention would be modified accordingly.

What is claimed is:

1. A module adapted for attachment to a firearm, the module comprising:
a push-to-talk (PTT) accessory for a radio frequency communication device separate from the module;
a first activation button for the PTT accessory, the PTT accessory configured to emit a wireless signal when activated by the first activation button;
an illumination element; and
a second activation button, different from the first activation button, for the illumination element,
wherein the module is adapted to be fitted to the firearm so that the first activation button is positioned in proximity to an expected position of a user's index finger when the user is holding the firearm.

2. An illumination module for a firearm, comprising an illumination element and an activation button for the illumination element, the illumination module adapted to be fitted to the firearm about a magazine well and, when so fitted, to project light along an axis which is parallel to a plane defined by a magazine when seated in the magazine well.
